(19) United States
(12) Patent Application Publication
(10) Pub. No.: US 2019/0316571 A1
(43) Pub. Date: Oct. 17, 2019

(54) SMA BUNDLE PISTON CUSHIONING SYSTEM FOR USE IN AN ENERGY RECOVERY DEVICE

(71) Applicant: Exergyn Limited, Glasnevin, Dublin (IE)

(72) Inventor: Kevin O'Toole, Glasnevin, Dublin (IE)

(21) Appl. No.: 16/313,204

(22) PCT Filed: Jun. 28, 2017
(86) PCT No.: PCT/EP2017/066064

§ 371 Date: Dec. 26, 2018

(30) Foreign Application Priority Data
Jun. 28, 2016 (GB) 1611171.8

(51) Int. Cl. F03G 7/06

(52) U.S. Cl. CPC F03G 7/065

(57) ABSTRACT

The invention provides an energy recovery system comprising a plurality of Shape-Memory Alloy (SMA) or Negative Thermal Expansion (NTE) elements arranged as a plurality of wires positioned substantially parallel with each other to define a core; a hydraulic chamber in communication with one end of the core and adapted to convert movement of the core into energy; and an energy storage device adapted to provide a lower pressure relative to the pressure in the hydraulic chamber. The invention addresses an unbalance in stress distribution across the SMA bundle that occurs as a result of the mechanism of fluid input into the SMA core. The net effect of the fluid dynamics at the entrance to the core is that SMA wires at the exterior of the bundle activate before wires on the interior of the bundle.

### FIELD

The present application relates to the field of energy recovery and in particular to the use of Shape-memory Alloys (SMAs) or Negative Thermal Expansion materials (NTE) for same.

### BACKGROUND

Low grade heat, which is typically considered less than 100 degrees, represents a significant waste energy stream in industrial processes, power generation and transport applications. Recovery and re-use of such waste streams is desirable. An example of a technology which has been proposed for this purpose is a Thermoelectric Generator (TEG). Unfortunately, TEGs are relatively expensive. Another largely experimental approach that has been proposed to recover such energy is the use of Shape-memory Alloys.

A Shape-memory Alloy (SMA) is an alloy that “remembers” its original, cold-forged shape which once deformed returns to its pre-deformed shape upon heating. This material is a lightweight, solid-state alternative to conventional actuators such as hydraulic, pneumatic, and motor-based systems.

The three main types of Shape-memory Alloys are the copper-zinc-aluminium-nickel, copper-aluminium-nickel, and nickel-titanium (NiTi) alloys but SMAs can also be created, for example, by alloying zinc, copper, gold and iron.

The memory of such materials has been employed or proposed since the early 1970's for use in heat recovery processes and in particular by constructing SMA engines which recover energy from heat as motion. Recent publications relating to energy recovery devices include PCT Patent Publication number WO2013/087490, assigned to the assignee of the present invention. It is desirable to translate the contraction of the SMA or NTE material into a mechanical force in an efficient manner. It is not a trivial task and generally is complicated and involves significant energy losses.

It is therefore an object to provide an improved system and method in an energy recovery device.

### SUMMARY

According to the invention there is provided, as set out in the appended claims, an energy recovery system comprising a plurality of Shape-Memory Alloy (SMA) or Negative Thermal Expansion (NTE) elements arranged as a plurality of wires positioned substantially parallel with each other to define a core; a hydraulic chamber in communication with one end of the core and adapted to convert movement of the core into energy; and an energy storage device adapted to provide a low pressure relative to the pressure in the hydraulic chamber.

In one embodiment the energy storage device comprises a pressure accumulator.

In one embodiment wherein upon initial activation of the energy storage device, the core is only subjected to the low pressure of the accumulator, thus reducing the stresses on the wires that have activated to provide a cushioning effect.

In one embodiment the energy recovery system comprises a valve.

In one embodiment the valve is a one way valve and adapted to open when a sufficient number of wires in the core are activated.

In one embodiment the valve is configured to open to provide a substantially equal or similar pressure in the hydraulic chamber and the energy storage device.

In one embodiment the hydraulic chamber is in communication with one end of the core via a piston.

In a further embodiment there is provided a method of recovering energy comprising the steps of arranging a plurality of Shape-Memory Alloy (SMA) or Negative Thermal Expansion (NTE) elements as a plurality of wires positioned substantially parallel with each other to define a core; coupling a hydraulic chamber with one end of the core and converting movement of the core into energy; and providing a low pressure relative to the pressure in the hydraulic chamber by using an energy storage device.

In another embodiment there is provided an energy recovery system comprising a plurality of Shape-Memory Alloy (SMA) or Negative Thermal Expansion (NTE) elements arranged as a plurality of wires positioned substantially parallel with each other to define a core; a chamber in communication with one end of the core and adapted to convert movement of the core into energy; and an energy storage device adapted to provide a low pressure relative to the pressure in the chamber.

In another embodiment there is provided a method of recovering energy an energy recovery system comprising a plurality of Shape-Memory Alloy (SMA) or Negative Thermal Expansion (NTE) elements arranged as a plurality of wires positioned substantially parallel with each other to define a core; a chamber in communication with one end of the core and adapted to convert movement of the core into energy; and an energy storage device adapted to provide a low pressure relative to the pressure in the chamber.

### BRIEF DESCRIPTION OF THE DRAWINGS

The invention will be more clearly understood from the following description of an embodiment thereof, given by way of example only, with reference to the accompanying drawings, in which:—

FIG. 1 illustrates a known energy recovery system;

FIG. 2 illustrates uneven wire activation as a result of fluid input dynamics;

FIG. 3 illustrates a first embodiment of the invention showing initial stroke where not all SMA wires in the bundle are activated; and

FIG. 4 illustrates a first embodiment of the invention showing initial Stroke where most or all of the SMA wires in the bundle activated.

### DETAILED DESCRIPTION OF THE DRAWINGS

The invention relates to a heat recovery system under development which can use either Shape-memory Alloys (SMAs) or Negative Thermal Expansion materials (NTE) to generate power from low-grade heat.

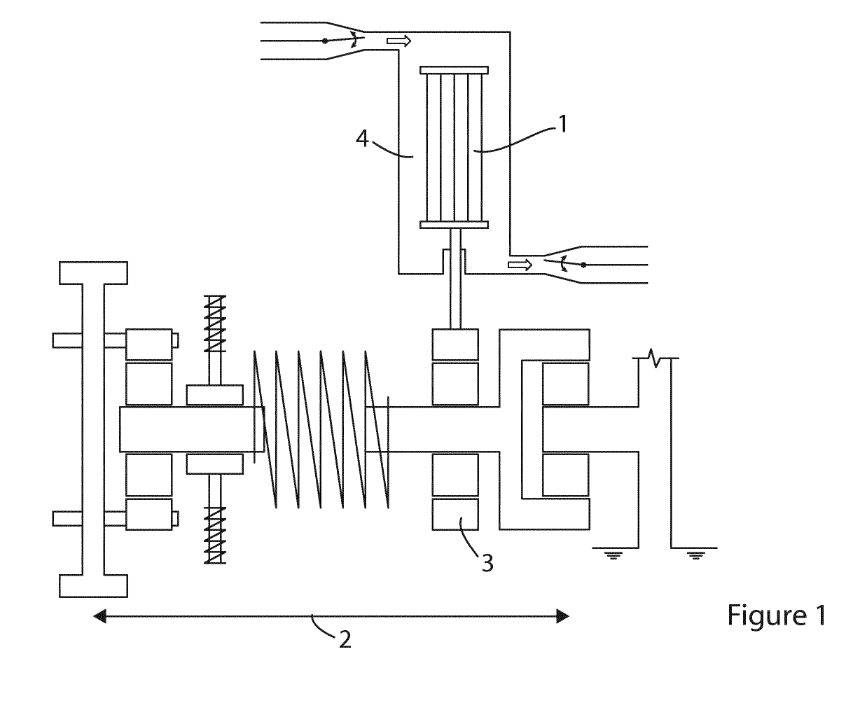

An exemplary known embodiment of an energy recovery device will now be described with reference to FIG. 1 which provides an energy recovery device employing a SMA engine indicated by reference numeral 1. The SMA engine 1 comprises an SMA actuation core. The SMA actuation core is comprised of SMA material clamped or otherwise secured at a first point which is fixed. At the opposing end, the SMA material is clamped or otherwise secured to a drive mechanism 2. Thus whilst the first point is anchored the second point is free to move albeit pulling the drive mechanism 3. An immersion chamber 4 is adapted for housing the SMA engine and is also adapted to be sequentially filled with fluid to allow heating and/or cooling of the SMA engine. Accordingly, as heat is applied to the SMA core it is free to contract. Suitably, the SMA core comprises a plurality of parallel wires, ribbons or sheets of SMA material. It will be appreciated that in the context of the present invention the term ‘wire’ is used and should be given a broad interpretation to mean any suitable length of SMA or NTE material that can act as a core.

Typically, a deflection in and around 4% is common for such a core. Accordingly, when a 1 m length of SMA material is employed, one might expect a linear movement of approximately 4 cm to be available. It will be appreciated that the force that is provided depends on the mass of wire used. Such an energy recovery device is described in PCT Patent Publication number WO2013/087490, assigned to the assignee of the present invention, and is incorporated fully herein by reference.

For such an application, the contraction of such material on exposure to a heat source is captured and converted to usable mechanical work using a hydraulic chamber and piston. In the context of the present invention the hydraulic chamber and piston should be interpreted broadly to cover any suitable transmission system. A useful material for the working element of such an engine has been proven to be Nickel-Titanium alloy (NiTi). This alloy is a well-known Shape-Memory Alloy and has numerous uses across different industries. It will be appreciated that any suitable SMA or NTE material can be used in the context of the present invention.

Force is generated through the contraction and expansion of this alloy (presented as a plurality of wires) within the working core, via a piston and transmission mechanism. Accordingly, depending on the requirements of a particular configuration and the mass of SMA material needed, a plurality of SMA wires may be employed together, spaced substantially parallel to each other, to form a single core.

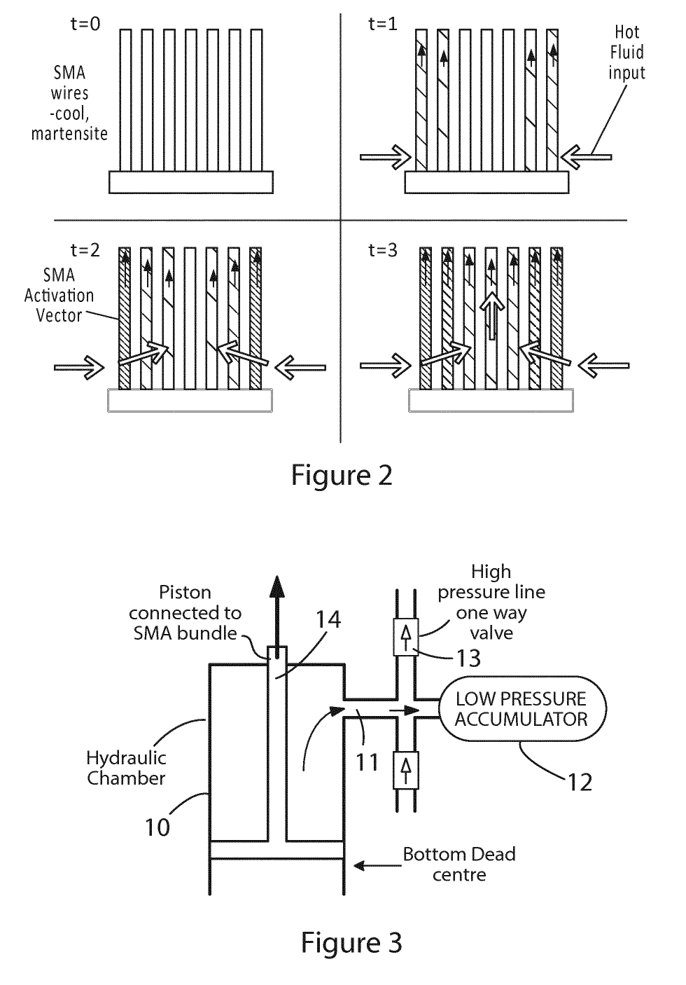

A problem with the core having a plurality of wires is the uneven heating of the wires in the core as shown in FIG. 2 where four different temperature states are shown at t=0, t=1; t=2 and t=3. The invention addresses an unbalance in stress distribution across the SMA bundle of wire elements that occurs as a result of the fluid dynamics at the entrance to the SMA core, and as the fluid travels up through the core. The net effect of the fluid dynamics is that SMA wires at the exterior of the bundle activate before wires on the interior of the bundle due to a larger convective heat transfer coefficient at the entrance due to turbulent flow (compared to the relatively laminar flow further up the bundle), and the fact that the wires on the exterior of the bundle are impacted earliest. This leads to wear and fatigue in the exterior wires closest to the fluid entrances. Once these wires are fatigued, the next closest wires to the exterior wires are then subject to the same mechanism, resulting in a core that gradually fails from the outside in. It is an object of the invention to overcome this problem.

In one embodiment there is provided an energy recovery system comprising a plurality of Shape-Memory Alloy (SMAs) or Negative Thermal Expansion (NTE) elements arranged as a plurality of wires (or elements) positioned substantially parallel with each other to define a core. A hydraulic chamber is in communication with one end of the core and adapted to convert movement of the core into energy. An energy storage device, for example an accumulator device, is adapted to provide a lower pressure relative to the pressure in the hydraulic chamber.

The invention addresses an unbalance in stress distribution across the SMA bundle that occurs as a result of the mechanism of fluid input into the SMA core. The net effect of the fluid dynamics at the entrance to the core is that SMA wires at the exterior of the bundle activate before wires on the interior of the bundle.

The wires activating on the exterior of the core would be subjected to the full load of the system, whereas the load should be evenly spread across all wires in the bundle, which naturally happens when all or most of the wires are engaged.

The energy storage device is adapted to provide a low pressure relative to the pressure in the hydraulic chamber. The energy storage device can be a small low pressure accumulator 12 on the outside of the hydraulic chamber 10 set to a pressure below that of a high pressure line with a one way valve 13. Alternatively the accumulator can be in the chamber but configured to be physically separated from the pressure in the chamber and connected by a valve controlled channel or the like. The accumulator can be positioned at any location relative the chamber. The net effect of this is that upon initial activation, the SMA bundle is only subjected to the low pressure of the accumulator 12, thus reducing the stresses on the wires that have activated by providing a cushioning effect. When all of the wires are activated or engaged, the pressure is enough to open a one way valve on the high pressure line, engaging the core and producing a power stroke.

FIG. 3 illustrates a first embodiment of the invention showing Initial Stroke where not all SMA wires in the bundle activated. As can be seen, a hydraulic chamber 10 comprises an outlet 11 connected to an accumulator 12 and a high pressure line with a one way valve 13. FIG. 3 depicts where only a few wires of the core are activated. As the accumulator provides a low or negative pressure relative to the hydraulic chamber then a piston 14 connected to the SMA bundle of wires is not actuated.

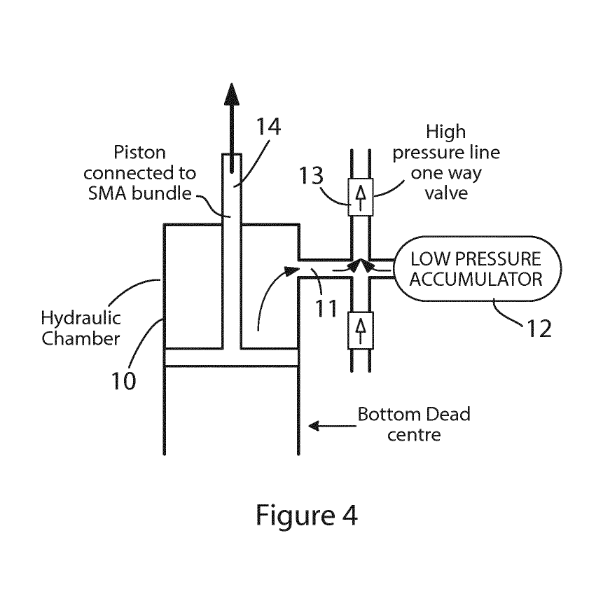

In FIG. 4, similar to FIG. 3, operation of the invention illustrates where most or all of the wires in the core are actuated. The one way valve 13 is in the open position as the pressure from most of the wires contracting overcomes the low pressure provided by the accumulator 12 thereby allowing the piston 14 to fully engage and convert energy from contraction/expansion of the core into usable energy.

Upon cooling of the core (the wire elements), and hence the return of the wires to the martensitic state, the low pressure accumulator returns the fluid to the hydraulic chamber to aid relaxation. The knock on effect of cushioning is a loss in usable stroke length on the power stroke so efforts should be made to reduce the need for cushioning in some applications.

The embodiments in the invention described with reference to the drawings comprise a computer apparatus and/or processes performed in a computer apparatus. However, the invention also extends to computer programs, particularly computer programs stored on or in a carrier adapted to bring the invention into practice, for example controlling the valve and the pressure in the chamber and/or the accumulator device. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. An energy recovery system comprising a plurality of Shape-Memory Alloy (SMA) or Negative Thermal Expansion (NTE) elements arranged as a plurality of wires positioned substantially parallel with each other to define a core; a hydraulic chamber in communication with one end of the core and adapted to convert movement of the core into energy; and an energy storage device adapted to provide a low pressure relative to the pressure in the hydraulic chamber.

2. The energy recovery system as claimed in claim 1 wherein the energy storage device comprises a pressure accumulator.

3. The energy recovery system as claimed in claim 1 wherein upon initial activation of the energy storage device, the core is only subjected to the low pressure of the accumulator, thus reducing the stresses on the wires that have activated to provide a cushioning effect.

4. The energy recovery system as claimed in claim 1 comprising a valve.

5. The energy recovery system as claimed in claim 4 wherein the valve is a one way valve and adapted to open when a sufficient number of wires in the core are activated.

6. The energy recovery system as claimed in claim 4 wherein the valve is configured to open to provide an outlet path to allow an equal pressure in the hydraulic chamber and the energy storage device.

7. The energy recovery system as claimed in claim 1 wherein the hydraulic chamber is in communication with one end of the core via a piston.

8. A method of recovering energy comprising the steps of arranging a plurality of Shape-Memory Alloy (SMA) or Negative Thermal Expansion (NTE) elements as a plurality of wires positioned substantially parallel with each other to define a core; coupling a hydraulic chamber with one end of the core and converting movement of the core into energy; and providing a low pressure relative to the pressure in the hydraulic chamber by using an energy storage device.

9. An energy recovery system comprising a plurality of Shape-Memory Alloy (SMA) or Negative Thermal Expansion (NTE) elements arranged as a plurality of wires positioned substantially parallel with each other to define a core; a chamber in communication with one end of the core and adapted to convert movement of the core into energy; and an energy storage device adapted to provide a low pressure relative to the pressure in the chamber.
